(19) United States
(12) Patent Application Publication
(10) Pub. No.: US 2014/0151511 A1
(43) Pub. Date: Jun. 5, 2014

(54) AIRCRAFT WITH AT LEAST TWO AIRCRAFT FUSELAGES AND TWO MAIN WINGS

(71) Applicant: Airbus Operations GmbH, Hamburg (DE)

(72) Inventor: Gerd Heller, Hellwege (DE)

(73) Assignee: Airbus Operations GmbH, Hamburg (DE)

(21) Appl. No.: 14/096,554

(22) Filed: Dec. 4, 2013

Related U.S. Application Data
(60) Provisional application No. 61/733,463, filed on Dec. 5, 2012.

(30) Foreign Application Priority Data
Dec. 5, 2012 (DE) 10 2012 023 821.5

(51) Int. Cl. B64C 39/04; B64C 39/08

(52) U.S. Cl. CPC B64C 39/04; B64C 39/08
USPC 244/45 R

(57) ABSTRACT

An aircraft includes at least two aircraft fuselages and two elongate main wings, wherein the main wings each have an extension direction which are at an angle to one another that differs from zero. Each of the two main wings is connected to the at least two aircraft fuselages. The main wings can thus be equipped mechanically simply and so as to have a low weight, and at the same time the transmission of forces between the wings and the fuselages is performed via a plurality of connections, and this leads to a relatively low material stress.

### CROSS-REFERENCE TO RELATED APPLICATIONS

This application claims the benefit of the filing date of U.S. Provisional Patent Application No. 61/733,463 filed Dec. 5, 2012, the disclosure of which is hereby incorporated herein by reference.

### TECHNICAL FIELD

The invention relates to an aircraft comprising at least two aircraft fuselages and two main wings.

### BACKGROUND OF THE INVENTION

An aircraft configuration is usually characterised by the arrangement of one or more main wings, auxiliary wings, tail units and at least one fuselage. While, in scheduled air traffic, conventional aircraft having a low cruising speed often comprise substantially continuously elongate main wings comprising a straight leading edge, larger commercial aircraft having cruising speeds in the transonic range are usually provided with two main wing halves, the leading edges of which are positively swept. In this case, the leading edges extend obliquely from a wing root located on the aircraft fuselage counter to the direction of flight and, in this case, are at a predetermined sweep angle to a transverse axis of the aircraft. Owing to the sweep, aerodynamically disadvantageous effects of the flow speed in the transonic range can be improved by reducing the effective speed component of the flow which acts vertically on the leading edges, such that, inter alia, the characteristic impedance is reduced and the directional stability of the main wing is improved. This effect can also be achieved by a negative sweep, in which the leading edges of the swept aerofoil halves extend forwards from a wing root in the direction of flight. In contrast to elongate wings comprising a continuously straight leading edge, the mechanical wing structure comprising swept leading edges is often significantly more complex.

In addition to symmetrical aircraft configurations, which for example consist of a single aircraft fuselage, a swept main wing arranged on the aircraft fuselage and a tail unit assembly, asymmetrical aircraft configurations are known which provide an elongate main wing which is or can be turned about a vertical axis of the aircraft and has a straight leading edge. One aerofoil half thus has a positive sweep, while the other aerofoil half has a negative sweep.

### BRIEF SUMMARY OF THE INVENTION

An aspect of the invention proposes an aircraft comprising a main wing, the mechanical structure of which is as simple as possible, the aircraft nevertheless having high aerodynamic efficiency for a flight in the transonic speed range

In an embodiment, the aircraft comprises at least two aircraft fuselages and two elongate main wings, wherein the main wings each have an extension direction and wherein the extension directions of the two main wings are at an angle to one another that differs from zero. Each of the two main wings is connected to the at least two aircraft fuselages. This may provide an aircraft comprising a main wing, the mechanical structure of which is simple, the aircraft nevertheless having high aerodynamic efficiency for a flight in the transonic speed range.

In this case, an elongate main wing is considered to be a mechanically simply constructed wing having a continuously elongate shape, which has a straight or substantially straight leading edge. Since the extension directions of the two main wings are at an angle to one another, at least one of the two main wings has a sweep. The sweep angle may be selected such that the characteristic impedance in the transonic speed range can be reduced. The sweep angle may be measured approximately on the 25% line of the local wing profiles, and alternatively or in addition on the leading edge. In a configuration of the aircraft which is symmetrical in plan view, the two main wings have an equal sweep angle. The aircraft according to the invention can be readily configured for transonic flight.

The main wings may be dimensioned such that they extend over the at least two aircraft fuselages in the transverse direction. Each of the two main wings thus comprises a front wing portion, a rear wing portion and a central wing portion. In this case, the front wing portion protrudes outwards on the outside of one of the aircraft fuselages and extends in the direction of flight. The rear wing portion extends outwards on the opposite side of the aircraft fuselage counter to the direction of flight. The central wing portion is positioned between the two aircraft fuselages and complements the front and rear wing portions to form an entire main wing. The front wing portion can be considered to be a negatively swept wing, and the rear wing portion can be considered to be a positively swept wing. The main wings are preferably tapered, such that the local chord of the main wing decreases at least in an end region. With a given wing tapering but the same sweep, a relatively low leading-edge sweep arises for the negatively swept front wing portion in comparison with the rear wing portion in the region of the tapering. With identical transonic behaviour, this may promote laminar flow.

It may be a particularly positive side effect that a tail unit in the conventional sense can be entirely omitted, since a rear wing portion and a front wing portion can perform all the functions of a tail unit when appropriately designed. In this case, similarly to a canard configuration or a tandem configuration, a conventional horizontal tail plane may not be required for generating restoring moments.

The use of two main wings may also lead to the extension in a horizontal direction of the aircraft according to the invention being comparatively low, such that it can take off and land at all airports suitable for commercial aircraft without difficulty.

The design of two mutually separate main wings each having an elongate extension results in each main wing having a mechanically simple structure, and this in turn leads to a particularly low weight. At the same time, the entire aerodynamic load is distributed over as large an area as possible by integrating two separate main wings. As a result, each individual main wing can be relatively slim compared to a conventional commercial aircraft comprising a single main wing. The aircraft according to the invention thus has a relatively low weight.

The main wings do not necessarily have to be planar, that is to say extending in one plane. It may also be suitable for the main wings to each have a V shape, it being possible for said wings to be produced by planar partial surfaces and/or a partly continuous or entirely continuous curved shape. In this case, each main wing could have a positive V shape in regions and/or a negative V shape in regions. Depending on the positioning of each main wing in the vertical direction, one V shape or the other may be suitable, combinations of reflexed or double-reflexed shapes in plan view of the y-z plane of the aircraft are of course also conceivable. It is particularly advantageous, more particularly to aid the starting rotation, to increase the ground clearance by an increasing V angle in the region of the rear wing portions.

The two main wings can each comprise primary and secondary control surfaces, in order to allow primary and/or secondary flight control by influencing the flow by moving the control surfaces. In principle, it may be conceivable to integrate a plurality of control surfaces for different purposes, which are also adapted for different speed ranges and can also compensate asymmetric effects if there is asymmetry. This can also include control surfaces, which enable a variable arching for load monitoring in cruising flight and may be used simultaneously as landing flaps for flying at low speeds during take-off and landing.

Owing to the connection of the two main wings to the at least two aircraft fuselages, there are at least four connection regions in which force is transmitted between an aircraft fuselage and a main wing. In comparison with a conventional commercial aircraft having only one central fuselage and a single connection point to a main wing in a relatively large wing-root region, the connection regions of the aircraft according to the invention can be designed to be significantly mechanically simpler, since the local load to be transmitted by the connection is relatively low. The multiplication of the load paths leads overall to a significantly more harmonious load transmission, since bending moments in the wing roots and adjacent wing regions are significantly lower than in a transonic aircraft configuration which is standard in the prior art, since only partial loads are introduced instead of the total load of a main wing or of a wing half.

In addition, the configuration of the landing gear of the aircraft according to an exemplary embodiment of the invention may be simple, since two or more fuselages are available, which may each include main landing gear and nose landing gear. The landing shock can be passed into the structure relatively harmoniously by the at least four regions of connection to the two main wings.

In another embodiment, the main wings are vertically mutually offset or vertically staggered, in order to reduce the mutual aerodynamic influence in the proximity of the smallest spacing between said wings. To further increase this spacing, the wings can be non-planar. In addition, it would be conceivable to install a mechanical connector in a region on or around the point of the largest spacing between the vertically offset wings. The mechanical integrity and stability could be significantly increased thereby. This mechanical connector can be produced as a vertically arranged, swept surface or a slim strut, and alternatively also as a central aircraft fuselage. Similarly to the staggering in known double decker configurations, the vertical offset leads to a reduced, lift-dependent amount of resistance which is approximately ⅔ of the lift-dependent amount of resistance of a conventional aircraft configuration comprising only one main wing and having the same load. In an advantageous embodiment, a first main wing can be arranged on the upper faces of the at least two aircraft fuselages, while a second main wing can be arranged on the undersides of the at least two aircraft fuselages. As a result, moment equilibrium about all the axes of the aircraft results overall; however, in this case, the elongate, slim and harmonious design of the main wings does not have to be dispensed with per se. A connection point between the respective main wing and the respective aircraft fuselage can more preferably be aerodynamically advantageously cladded.

In another embodiment, the two main wings are also offset in the longitudinal direction. As a result, the intersection point of the leading edges of the main wings is thus not on the longitudinal axis of the aircraft, but offset laterally therefrom. Advantageously, in this context, the upper main wing could be shifted forwards.

Another embodiment of the aircraft comprises exactly two aircraft fuselages, the extension directions of which are aligned so as to be mutually parallel. The aircraft fuselages can be elongate and preferably cigar-shaped. A particularly low aerodynamic resistance is generated hereby, and at the same time the design of the elongate main wing is not influenced.

Another embodiment comprises at least one vertical tail unit, also denoted as rudder unit in the following, which is arranged on at least one of the at least two aircraft fuselages. The use of two rudder units which are each arranged on a rear end of an outer aircraft fuselage appears to be particularly suitable. A rudder unit may be attached to a rear end of the relevant aircraft fuselage.

In another embodiment, at least one engine is provided, which is arranged on the aircraft such that the total thrust is generated symmetrically to the longitudinal axis of the aircraft. The exact arrangement of the at least one engine can be selected relatively arbitrarily; however it is preferred for it to be positioned on a tail. If an odd number of aircraft fuselages are used which results in the aircraft according to the invention comprising, for example, two outer aircraft fuselages and a central aircraft fuselage, the engine could be fastened to the central aircraft fuselage. If, however, an even number of fuselages is desired, an even number of engines can be integrated, which are arranged minor-symmetrically about the longitudinal axis. In a particularly advantageous variant, the aircraft according to the invention comprises two aircraft fuselages, which are each provided with one or two engines in a tail region.

In another embodiment, the arrangement of the at least two aircraft fuselages is symmetrical to the longitudinal axis of the aircraft. The integration of two engines on the outer aircraft fuselages results in a symmetrical introduction of thrust.

In addition, at least one engine may be integrated on a rear end of each aircraft fuselage. In a simple case, one engine may be arranged on a rear end of an aircraft fuselage, it being necessary to consider an air supply, for example by engine inlets. An engine nacelle, which extends radially outwards from a rear end of an aircraft, could also be combined with a rudder unit which is located vertically thereabove or therebelow.

In another embodiment, each engine comprises an engine nacelle, which extends radially outwards such that it absorbs the boundary layer flow of the relevant aircraft fuselage at least in part. As a result, the flow resistance of the relevant aircraft fuselage can be reduced when compared with differing positioning of the respective engine.

In another embodiment, in a region between the at least two aircraft fuselages, the main wings are vertically mutually spaced further apart at at least one point than in adjacent regions of connection to the aircraft fuselages. This can be achieved by at least one of the main wings having an arching in this region in the wingspan direction which is directed away from the other main wing. This does not necessarily mean that the arching is only provided locally. Rather, it may also be useful for at least one main wing not to be entirely planar, but instead to have a certain continuous curve at least about the longitudinal axis or a vertical line on the leading edge thereof. In the relevant region, there can then be, for example, a point with the greatest spacing from the other main wing. As an alternative to the arching, the relevant region can also be provided with a V shape and planar partial surfaces. When arched, curved or in a V shape, a region of a lower main wing could have a lowest point, which has the greatest spacing from a main wing positioned thereabove, between the inner faces of the aircraft fuselages. It should also be noted that the wing segment which is positioned on the inner faces of the at least two aircraft fuselages is preferably positioned between landing gears arranged on the aircraft fuselages in the longitudinal direction. None of the main wings can therefore come close to the ground, even when the aircraft is in its most inclined position.

In another configuration, each main wing comprises a winglet on a rear portion of each main wing. In this context, a winglet is to be understood to be a wingtip shape arranged on the main wing, which more particularly results in a reduction of the induced resistance. Known winglets can comprise at least one curved region, in which the V angle is increased in the direction of movement in the wingspan extension, it likewise being possible to increase the sweep angle of the leading edge here and to lower the local chord. Countless variants of winglets are found in the prior art which can be used in or on an aircraft according to the invention. The integral design of a main wing and of a winglet arranged thereon is particularly recommended, such that the structure of each main wing is harmoniously formed. For example, DE 101 17 721 B4 discloses a winglet for significantly reducing the aerodynamic resistance of an aircraft.

In a somewhat more specific embodiment, the end of each main wing can have a vertical extension in a rear portion, such that sufficient directional stability is achieved by producing the wing ends of the rear wing portions with a vertical extension and therefore a lateral projection surface. Once, for example, winglets having a vertical extension are used, they can also ensure the directional stability when appropriately designed, and they thus function as rudder units. This does not necessarily mean that there cannot be additional, separate rudder units which are arranged on the aircraft fuselage, for example. Yaw could be controlled by flaps which are pivotably arranged on the wing ends, as well as by control surfaces, for example control flaps, which are arranged off-centre on the main wings.

In a further embodiment, outer aircraft fuselages each comprise at least one landing gear per se. If the aircraft is provided with an even number of aircraft fuselages, for example the two outer aircraft fuselages can each comprise main landing gear and nose landing gear. It would, however, also be possible to arrange only one main landing gear on each of the outer aircraft fuselages and one nose landing gear in the centre, that is to say on a longitudinal axis of the aircraft.

### BRIEF DESCRIPTION OF THE DRAWINGS

Further features, advantages and possible applications of the invention emerge from the following description of the embodiments and from the drawings. In this context, all of the disclosed and/or illustrated features in themselves, in combination and irrespective of the composition thereof in the individual claims or the dependencies thereof, form the subject matter of the invention. Furthermore, the same reference numerals in the figures denote the same or similar objects.

FIG. 1 is a three-dimensional view of an embodiment of the aircraft,

FIG. 2 is a front view of an embodiment of the aircraft,

FIG. 3 is a first side view of an embodiment of the aircraft,

FIG. 4 is a second side view of an embodiment of the aircraft,

FIG. 5 is a plan view of the underside of an embodiment of the aircraft, and

FIG. 6 is a three-dimensional view of the underside of an embodiment of the aircraft.

### DETAILED DESCRIPTION

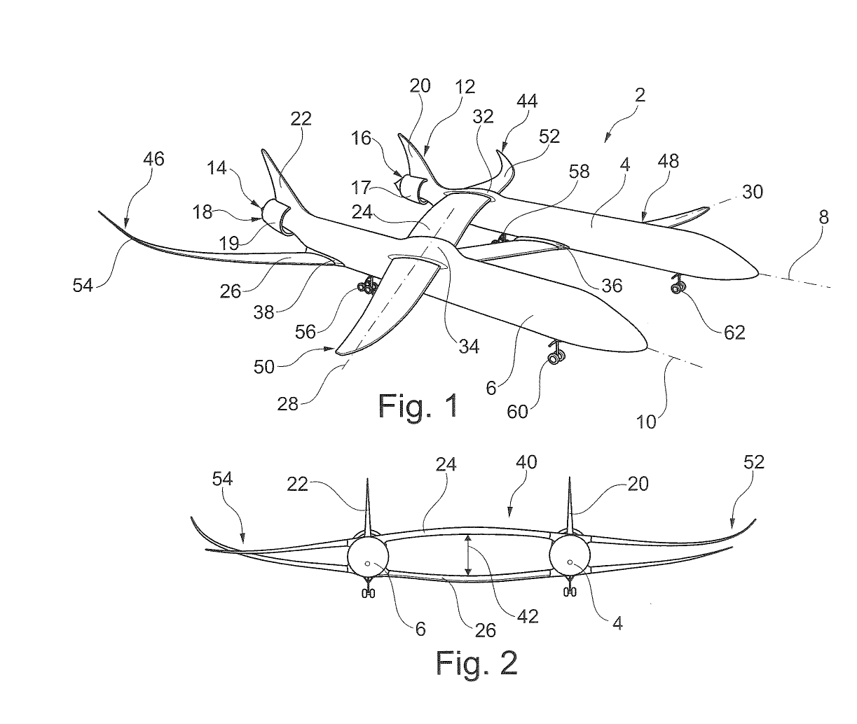

FIG. 1 shows an aircraft 2 according to an exemplary embodiment of the invention comprising a first aircraft fuselage 4 and a second aircraft fuselage 6, which each comprise an elongate, cigar-like shape having extension axes 8 and 10, which are mutually parallel. The aircraft fuselages 4 and 6 can be equipped for transporting passengers. In the figures of the drawings, for the sake of simplicity, details such as windows, doors and the like have been omitted, such that the emphasis is on the aircraft configuration.

By way of example, an engine 16 and 18 constructed as a turbojet engine is arranged on each rear end 12 and 14 of each aircraft fuselage 4 and 6, which engine is delimited towards the outside by an engine nacelle 17 and 19, which is clearly distinct from the aircraft fuselage 4 and 6 and projects radially outwards. The rear ends 12 and 14 of the aircraft fuselages 4 and 6 are also slightly tapered. A flow boundary layer, which is present on the aircraft fuselages 4 and 6 owing to the flow during flight, can therefore be easily absorbed by the engine nacelles 17 and 19 in order to be used in the combustion process or fed into a bypass flow. As a result, advantages emerge with respect to the aerodynamic resistance of the aircraft fuselages 4 and 6. On an upper face of each rear end of the aircraft fuselages, there are also rudder units 20 and 22, which each extend substantially vertically from an engine nacelle 17 and 19.

A particularity of the aircraft 2 may be the use of two slim, elongate main wings 24 and 26, which each have an extension direction 28 and 30. Each main wing 24 and 26 is connected to two aircraft fuselages 4 and 6, the extension axes 28 and 30 being at an angle to one another that differs from zero. This means that, as shown in FIG. 1, the two main wings 24 and 26 intersect.

The first main wing 24 is positioned, for example, on an upper face of the two aircraft fuselages 4 and 6, while the second main wing 26 extends on the undersides of the aircraft fuselages 4 and 6. Four connection regions 32, 34, 36 and 38 result therefrom in total, such that the total lift load to be introduced and the landing shock can be guided harmoniously between the two aircraft fuselages 4 and 6 and the main wings 24 and 26. As a result, there are low local stresses and thus only a low level of deformation.

The two aircraft fuselages 4 and 6 are mutually spaced and the two main wings 24 and 26 are arched in a vertical direction in a region 40 between the aircraft fuselages 4 and 6 such that, at this point, they have a larger vertical mutual spacing 42 than between the connection points 32, 36 and 34, 38 on the aircraft fuselages 4 and 6 respectively. As an alternative to the arching, the region 40 can also be provided with a V shape and planar partial surfaces. Owing to the mutually intersecting position of the two main wings 24 and 26, each of the main wings also comprises a rear portion 44 and 46 respectively and a front portion 48 and 50 respectively.

It is clear from FIG. 5 that the rear wing portions 44 and 46 extend outwards from the respective connection regions 36 and 38 thereof towards the rear and obliquely counter to the direction of flight. They can therefore be considered to be positively swept wings. In this case, the sweep angle of the leading edges should be selected from a standard angular range for transonic flight speeds, which can be for example between 20° and 45°.This also means that an angle δ between the extension directions 28 and 30 is in a range of between 40° to 90° when the aircraft is constructed symmetrically in the x-y plane and, as shown in FIG. 5 by way of example, when the leading edges of the main wings 24 and 26 extend parallel to the extension directions 28 and 30.

In the drawing, the rear portions 44 and 46 of the two main wings 24 and 26 each comprise a winglet 52 and 54, each of which is curved upwards towards the rear tip in the direction of movement. As mentioned above, various winglets can be used which are capable of reducing the resistance of the aircraft 2. The winglets 52 and 54 are preferably integral components of each main wing 24 and 26. The winglets 52 and 54 shown in the drawings are designed to be integral components of the main wings 24 and 26 and together with the respective main wing 24 and 26 form a harmonious, smooth outline. Alternatively, depending on the winglet used, there can also be kinks, straight portions or gaps in the local V shape in a region of connection to the winglets.

The front wing portions 48 and 50 are to be considered to be negatively swept wings owing to the oblique position thereof. The horizontal extension of the two main wings and of the front or rear portions thereof can be selected relatively freely, such that the horizontal extension of the front wing portions can be smaller or larger than that of the rear wing portions, or vice versa. For keeping at least part of the flow on the front wing portions 48 and 50 laminar, the leading edges can have a sweep angle which becomes smaller towards the outside, as is clear from the slightly rounded design in FIG. 5.

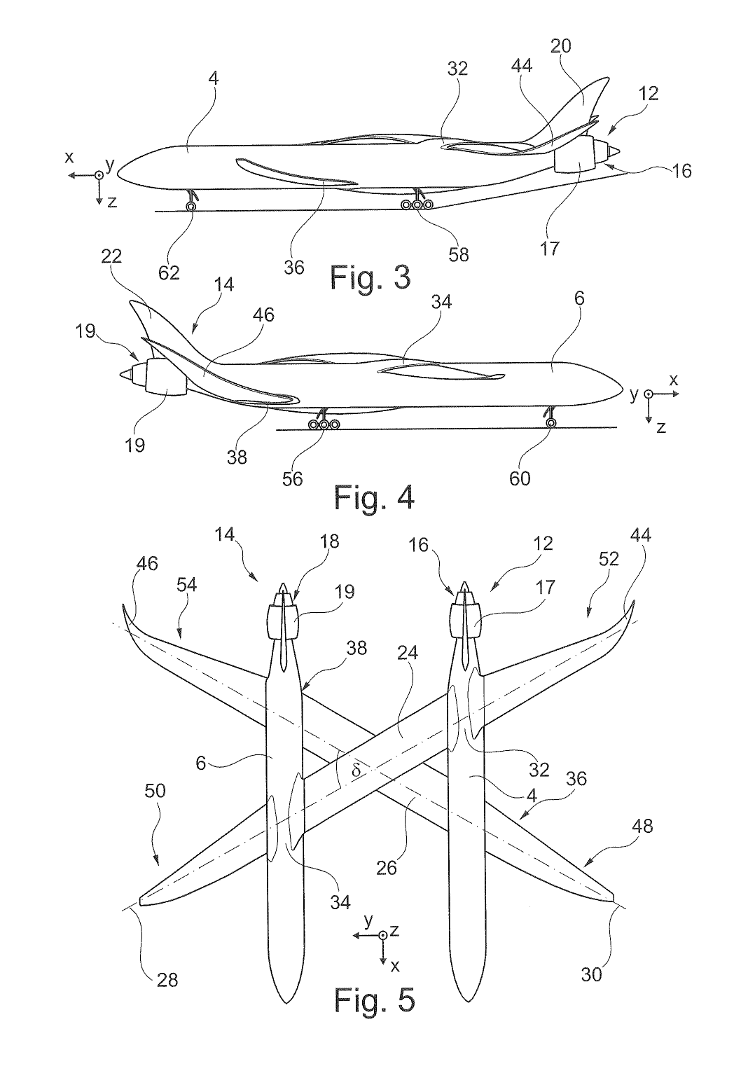

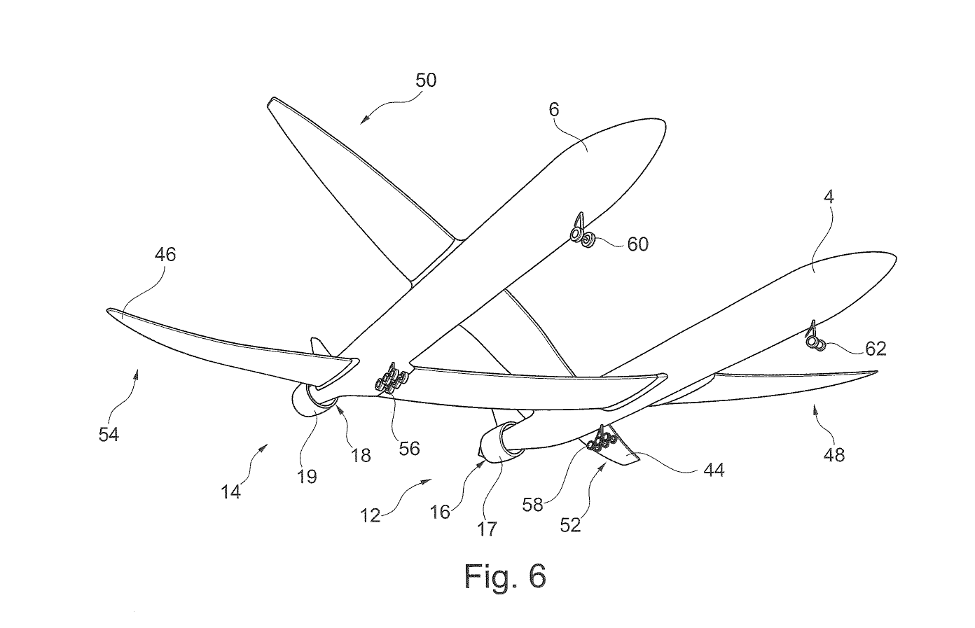

As is clear more particularly from the views in FIG. 3, FIG. 4 and FIG. 5, each of the two aircraft fuselages 4 and 6 comprises main landing gear 56 and 58 respectively and nose landing gear 60 and 62 respectively. The main landing gear can be arranged just in front of the rear fastening regions 32 and 38 respectively, while the nose landing gear is arranged well in front of the front fastening regions 34 and 36 respectively. In order to enable a starting rotation, the aircraft fuselages 4 and 6 are curved upwards at the rear ends 12 and 14 thereof. In addition, the ground clearance is increased by an increasing V angle in the region of the rear wing portions 52 and 54 and of the winglets 44 and 46.

The clear arrangement of the main components of the aircraft 2 allows for an even volume distribution in the direction of flight, and this leads to particularly advantageous resistance in the transonic flight range. The spatial separation of the aircraft fuselages 4 and 6 also allows for freight to be loaded and for passengers to board from several directions, that is to say from the outside and/or from the inside of each fuselage. The loading time and the boarding time as well as the time required for evacuation are thus reduced.

In addition, it should be noted that “comprising” does not exclude any other elements or steps and “a” or “an” does not exclude a plurality. It should also be noted that features which have been described with reference to one of the above embodiments can also be used combined with other features of other embodiments described above. Reference numerals in the claims should not be considered to be limiting.

1. An aircraft comprising: at least first and second aircraft fuselages and first and second elongate main wings, wherein the main wings each have an extension direction, wherein the extension directions of the two main wings are at an angle to one another that differs from zero and wherein each of the first and second main wings is connected to the at least first and second aircraft fuselages.

2. The aircraft according to claim 1, wherein the main wings are vertically mutually offset at least in regions.

3. The aircraft according to claim 1, wherein the first and second main wings are mutually offset in the longitudinal direction at least in regions.

4. The aircraft according to claim 1, comprising exactly first and second aircraft fuselages, the extension directions of which are aligned so as to be mutually parallel.

5. The aircraft according to claim 1, further comprising at least one vertical tail unit arranged on a rear end of at least one of the at least first and second aircraft fuselages.

6. The aircraft according to claim 1, further comprising at least one engine arranged on the aircraft such that the total thrust is generated by the at least one engine symmetrically to a longitudinal axis of the aircraft.

7. The aircraft according to claim 1, wherein an engine is arranged on each rear end of first and second external aircraft fuselages.

8. The aircraft according to claim 7, wherein each engine comprises an engine nacelle extending radially outwards such that the nacelle absorbs the boundary layer flow of the aircraft fuselage on which the nacelle is arranged at least in part.

9. The aircraft according to claim 1, wherein, in a region between the at least first and second aircraft fuselages, the main wings are vertically mutually spaced further apart at at least one point than in adjacent connecting regions in which the main wings are connected to the aircraft fuselages.

10. The aircraft according to claim 1, further comprising a winglet on a rear portion of each main wing.

11. The aircraft according to claim 1, wherein the end of each main wing has a vertical extension in a rear portion.

12. The aircraft according to claim 1, wherein one of the first and second main wings is arranged on the upper faces of the at least first and second aircraft fuselages and the other of the first and second main wings is arranged on the undersides of the at least first and second aircraft fuselages.

13. The aircraft according to claim 1, comprising first and second outer aircraft fuselages, each comprising at least one landing gear.

14. The aircraft according to claim 1, wherein the main wings and the at least first and second aircraft fuselages are arranged mutually symmetrically in plan view.
